(19) United States
(12) Patent Application Publication
(10) Pub. No.: US 2002/0112527 A1
(43) Pub. Date: Aug. 22, 2002

(54) Detection of fluid leak sites in fluid containers

(76) Inventor: David A Nadin, Macclesfield (GB)

Correspondence Address: Nixon & Vanderhye, 1100 North Glebe Road 8th Floor, Arlington, VA, 22201-4714, US

(21) Appl. No.: 10/069,049

(22) PCT Filed: Jun. 26, 2001
(86) PCT No.: PCT/GB01/02806

(30) Foreign Application Priority Data
Jun. 28, 2000 (GB) 0015691.9

(51) Int. Cl. G01M 3/04

(52) U.S. Cl. 73/49.2; 73/40

(57) ABSTRACT

A method of locating a potential source of fuel leakage in an aircraft fuel tank including the steps of:

sealing a vacuum tight cover over the whole seam on the surface of the empty fuel tank where there is a suspected source of fuel leak;

removing the air between the cover and the surface;

measuring the vacuum between cover and the surface;

comparing the measured vacuum with a predetermined acceptable datum vacuum value.

The technique of sealing a vacuum tight cover to a surface is known as “bagging”.

The present invention relates to methods of detecting a site of fluid leakage from containers and more particularly, but not exclusively, the detection of fuel leak sites in the fuel storage structures of aircraft and other vehicles.

Throughout the aircraft industry there is a major problem with fuel leaks and air leakage in pressurised vessels such as fuselage cabins. The detection and mapping of fuel leaks has hitherto required physical entry into the aircraft's fuel tanks to examine the internal structure for deterioration of the sealant, poor adhesion of sealant to the aircraft structure, or damage to the structure.

Some known methods of leak detection determine the source of leaks in a container filled with the fluid but other methods determine the sites of potential fluid leakage using an empty fluid container. U.S. Pat. No. 3,809,898 is an example of the former type of method and describes a method of detecting aircraft fuel line leaks by dissolving trace amounts of a radio active gas in the fuel and measuring the level of radio active emanations along the fuel system.

U.S. Pat. No. 4,615,828 is another example of a method of detecting fuel leaks from a filled container. The method described employs colour variable indicators and comprises the steps of preparing and applying a water soluble non-staining indicator dye to a test surface, observing colour changes indicative of hydrocarbon leaks and removing the indicator dye from the test surface. U.S. Pat. Nos. 4,745,797 and 4,756,854 describe similar methods using colour variable indicators.

U.S. Pat. No. 4,897,551 describes a leak detector for monitoring the presence of a liquid having a characteristic fluorescent spectrum. The presence of the liquid is sensed by detection of a threshold level of collected radiation.

One example where an empty fuel tank is subjected to a method of detecting potential fuel leakage positions is described in Japanese patent JP07286930. The method described in this patent involves injecting a detection fluid i.e. a fluid containing a fluorescent material inside a fuel tank of an aircraft at high pressure. The fuel tank is sealed from the outside by sealants. After a fixed time, the leakage of the detection fluid is tracked back to its source on the fuel tank using the fluorescent qualities of the detection fluid.

WO98/25122A (Bell Avon) describes a method of detecting leak sources in multiple walled fluid storage tanks such as underground oil storage tanks. The inner tanks are usually flexible bladders. Bell Avon's patent proposes pumping out the space between the inner flexible bladder and the outer rigid tank and measuring the rate of decay of the vacuum between the two to give an indication of a leak. Aircraft fuel tanks are not constructed with such flexible inner bladders and accordingly do not lend themselves to adopt Bell Avon's method of leak detection. Moreover it would be impractical to apply a vacuum to the whole fuel containing structure of an aircraft or even an entire wing in this manner.

U.S. Pat. No. 3,949,596 A (Hawk) describes a method of leak testing seams, such as container seals or pipe joints, which does not require the application of a pressure differential to the entire surface of the container or joined sections. In Hawk's method a flexible, impervious, membrane is disposed over an area of the seamed surface to be leak checked and sealed around the outer edges. A preselected vacuum is then applied through an opening in the membrane to evacuate the space between the membrane and the surface being leak tested. If there is a leakage hole in the seam the pressure differential at the seam will be reduced and a rise in pressure in the vacuum line will be experienced, thus indicating a leak. To pinpoint the leak source, Hawk suggests repeating his method with smaller membranes. Such a method of pinpointing leak sources would be very time consuming if applied to aircraft fuel tank seams which can be tens of meters in length. Moreover Hawk's method does not determine quantitatively the size of leak involved which is essential in the case of aircraft structures where some leakage below a predetermined level is acceptable.

Where an aircraft's wings are used as fuel storage structures, as is quite common in the industry, fuel leaks on the outer surface of the wings are often readily apparent. Internal examination identifies the obvious primary origin of the leak, but there is a high risk of secondary fuel leaks or that the real source of the leak is elsewhere on the structure. These secondary fuel leaks or remote sources often do not become apparent until the primary leaks have been repaired, and the aircraft has been partly refuelled. When this occurs the tanks must be drained to enable a second internal examination to be carried out thus making the whole process time consuming.

It is an objective of the present invention to provide a low risk alternative method of leak source detection which will enable the detection of a leak at all its sources thus reducing the risk of undetected additional minor leaks, reducing aircraft downtime, increasing aircraft operational ability, and maintaining aircraft operational capability.

A secondary objective of the invention is to provide a method of leak source detection which is applicable to a variety of aircraft types and is capable of detecting fuel leak sources in fuel tanks or air leak sources in pressurised vessels such as fuselages and fuselage cabins.

According to the present invention a method of locating a potential source of fluid leakage in a fluid container includes the steps of:

circumferentially sealing a vacuum tight cover to a surface of the empty fluid container over a suspected source of fluid leak to form a bagged region of said surface;

removing the air between the cover and said bagged region of the surface;

measuring the vacuum between cover and the surface; and

comparing the measured vacuum with a predetermined acceptable datum vacuum value; and, where the measured vacuum exceeds the datum vacuum;

gaining physical access to the interior of the fluid container;

using a leak detector to check the suspect area from the inside; and,

recording the exact location of the source of fluid leaks.

The action of sealing a vacuum tight cover to the surface of the fluid container is referred to hereinafter as “bagging” and the vacuum tight cover is referred to hereinafter as the “bagging film”.

Preferably the predetermined acceptable vacuum value is determined by carrying out the first two of the above three steps on a surface of the fluid container in which there are no joints or seams and recording the maximum consistent vacuum i.e. the minimum consistent pressure achieved as the datum vacuum value.

Preferably the vacuum between the bagging film and said bagged region of the surface of the container is measured over a predetermined period of time and is compared with a predetermined acceptable drop in the datum vacuum value over the same predetermined time.

Once the exact location of the potential source of a fluid leak is determined it may be repaired in accordance with approved processes. The above method should then be repeated until no further leaks are apparent. The container should then be filled with fluid and monitored in the conventional manner for signs of fluid leak.

The method is particularly, though not exclusively, applicable to the detection of potential leak sites in aircraft fuel tanks. It may also be used to locate the source of air leaks in aircraft or other pressurised vessels e.g. fuselages.

The invention will now be described by way of example only and with reference to the accompanying drawings of which:

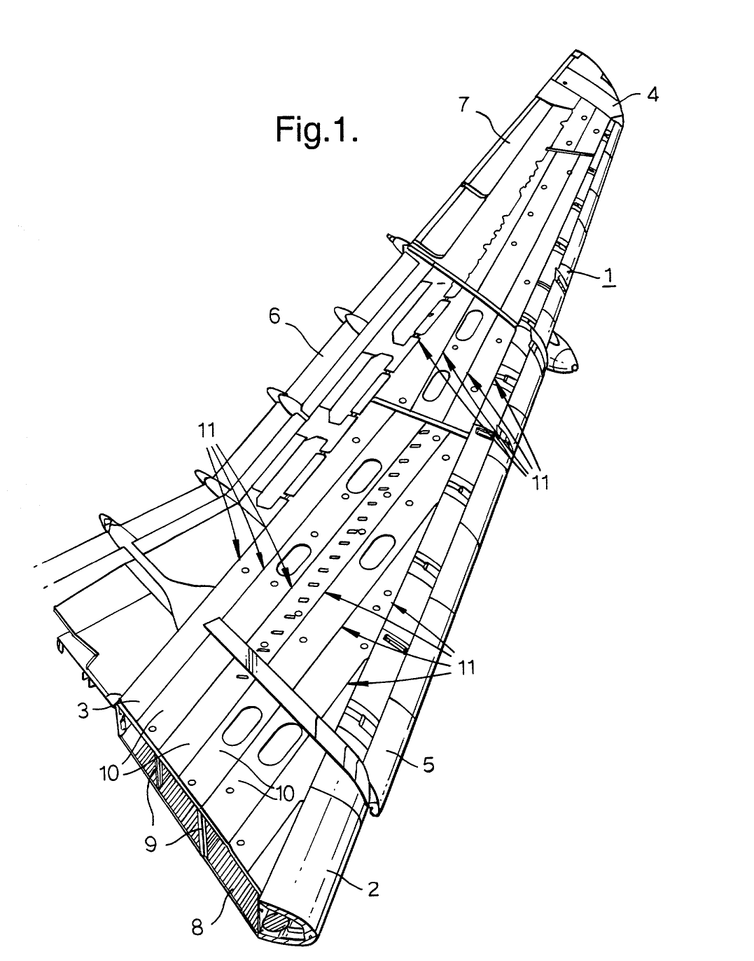

FIG. 1 is a perspective view of a typical aircraft fuel storing wing showing potential fuel leakage sites;

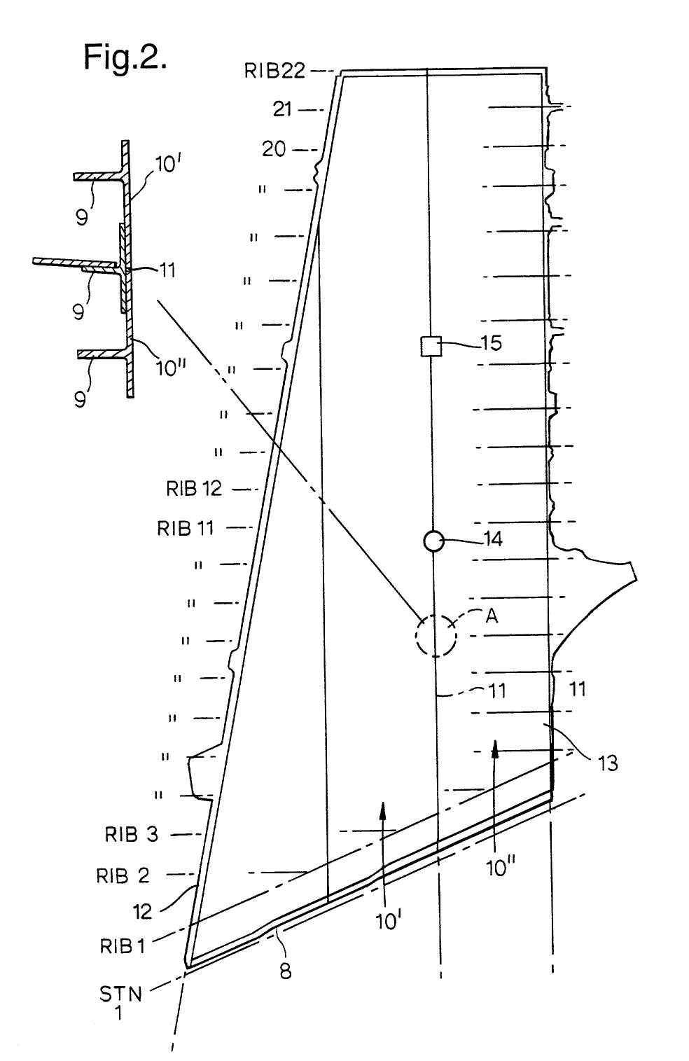

FIG. 2 is a sectioned plan view of part of the aircraft fuel storing wing of FIG. 1 with an enlarged insert showing typical joints between stringers and wing planks in cross section;

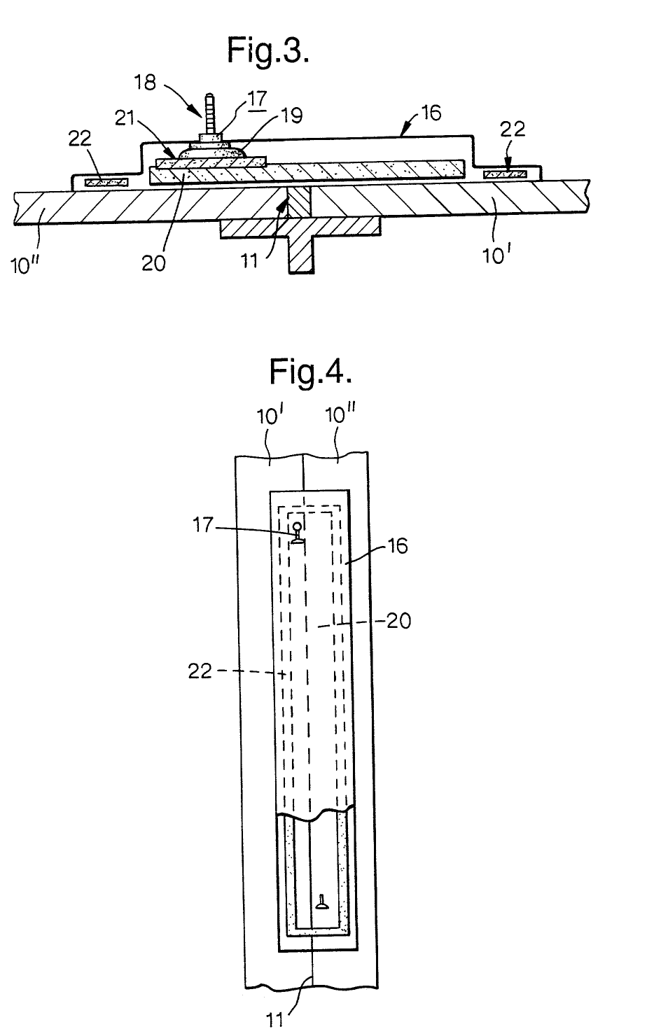

FIG. 3 is a sectioned front elevation of part of the aircraft wing of FIGS. 1 and 2 on which leak detection apparatus is mounted;

FIG. 4 is a plan view of a seam blanket or vacuum bag forming part of the leak detection apparatus shown in FIG. 3; and

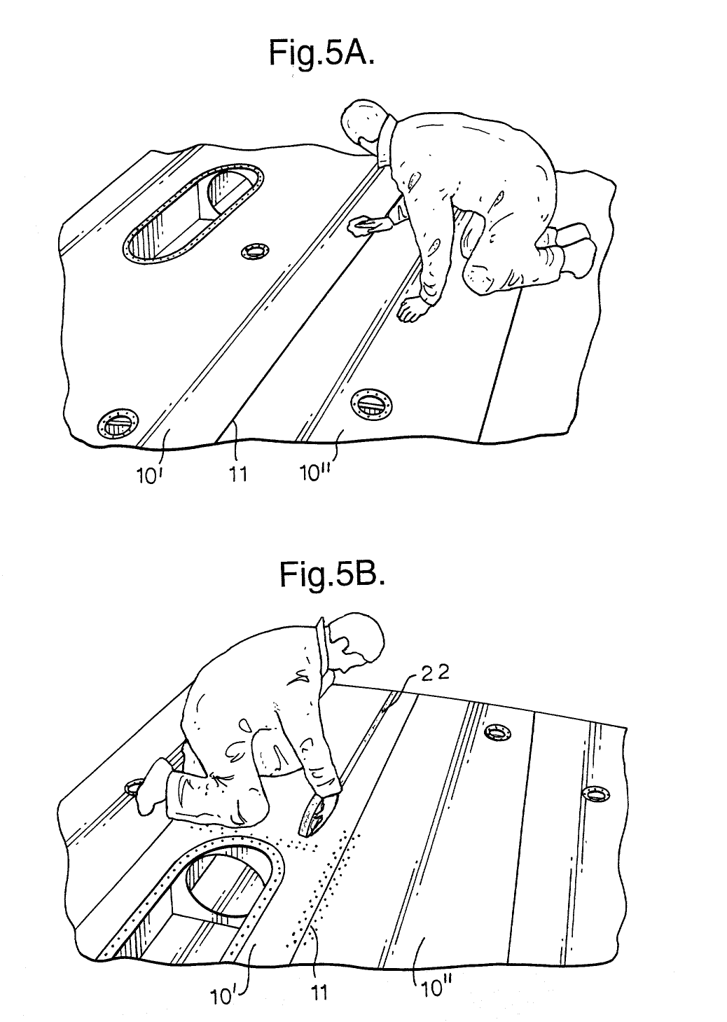

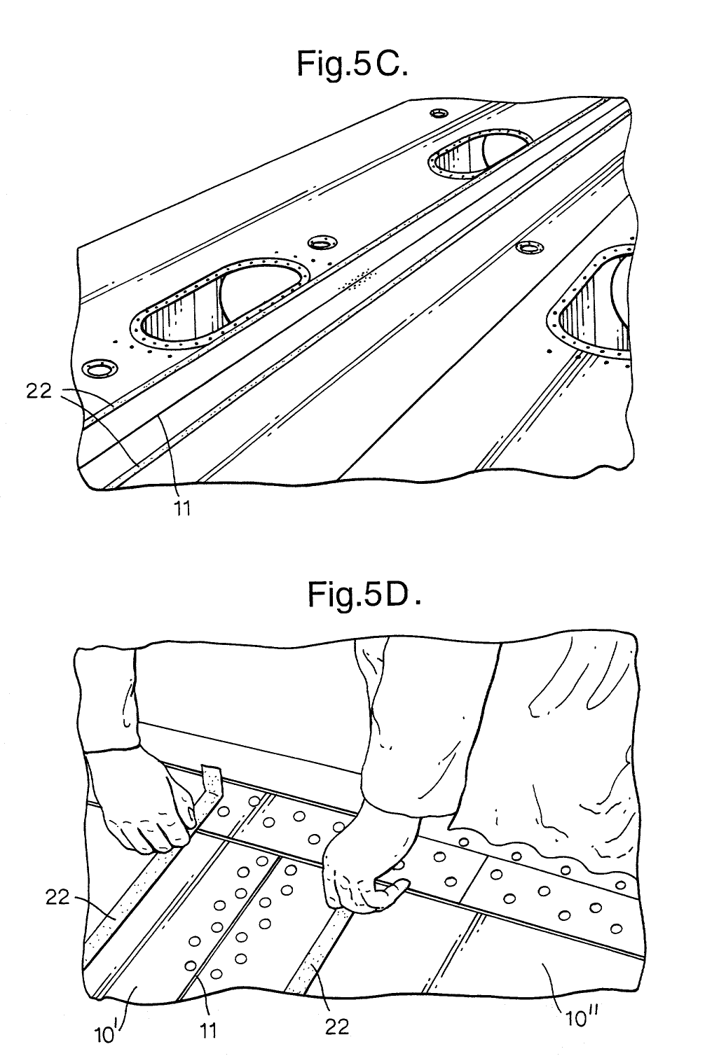

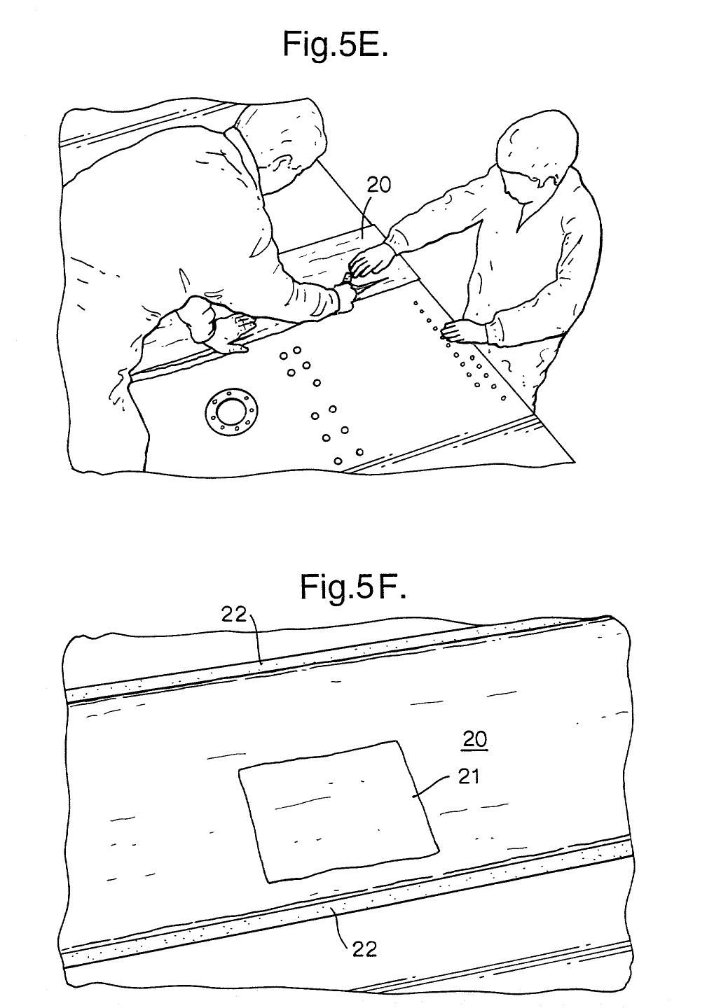

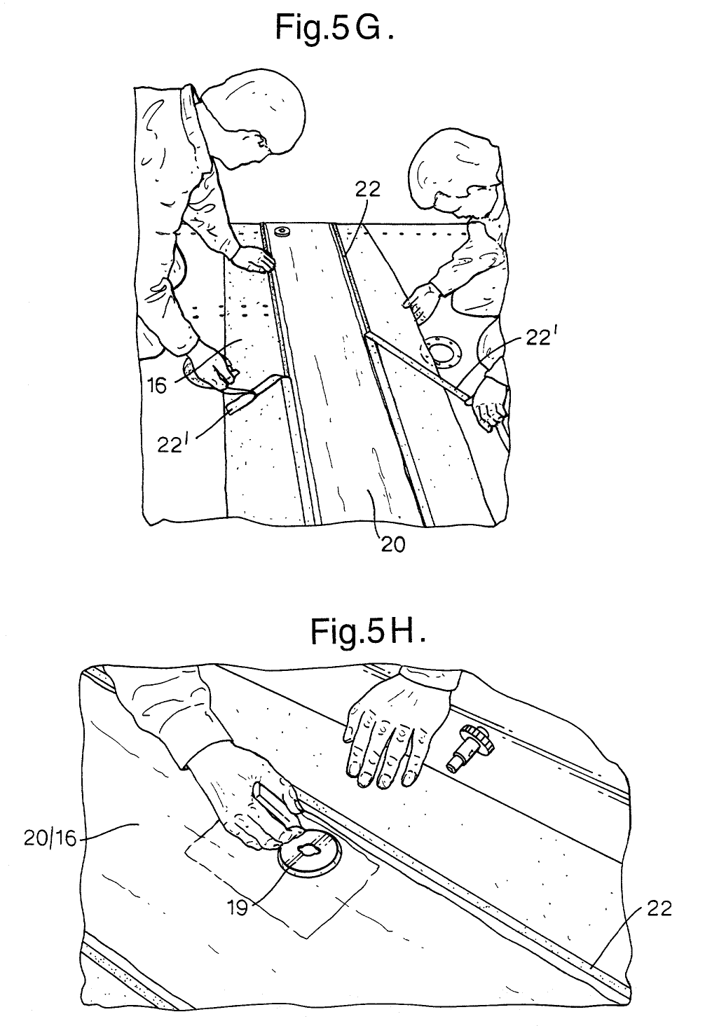

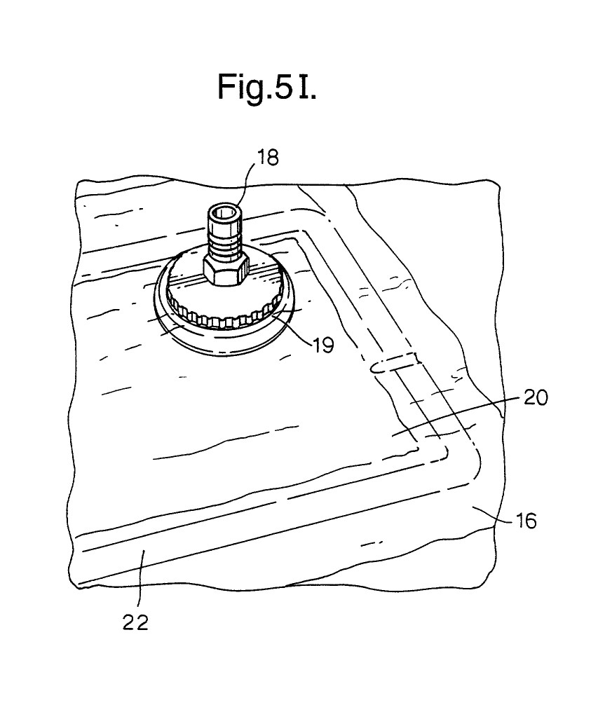

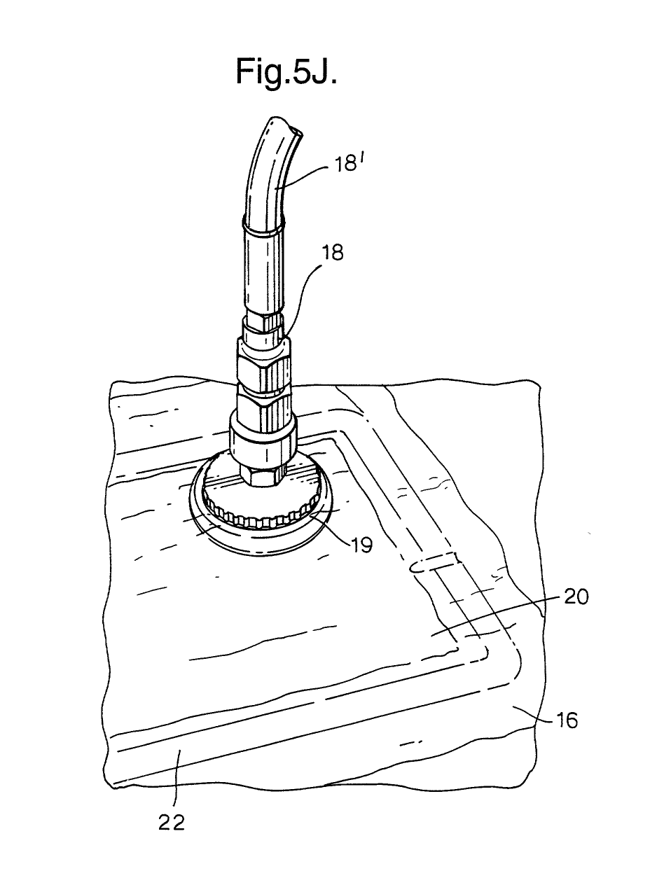

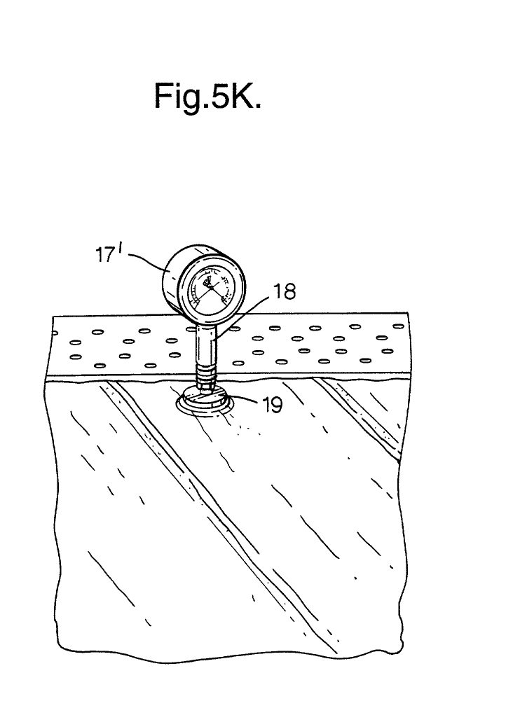

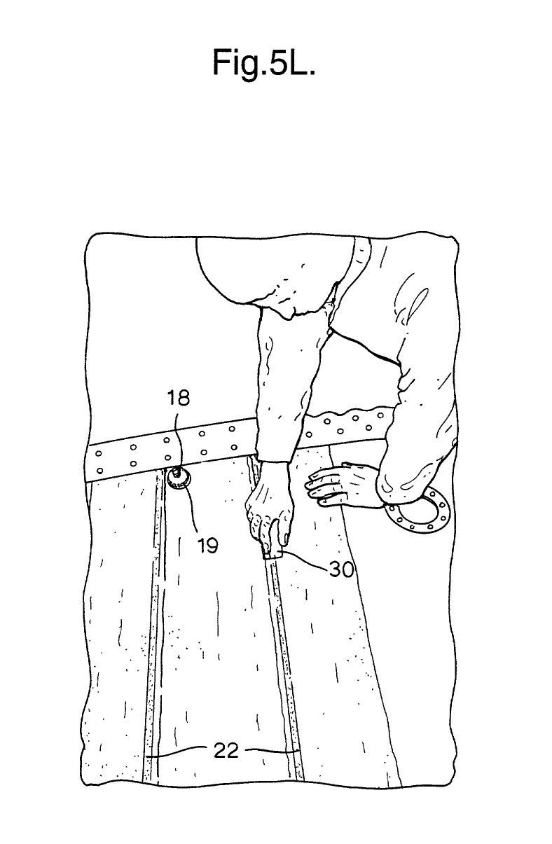

FIGS. 5A to 5L are photographs of the steps of an example of a method of applying the sealing bag on an aircraft wing in preparation for the detection of fuel leak sources.

In FIG. 1 a typical swept back wing 1 (in this case a port wing) is shown having a leading edge 2, a trailing edge 3, a wing tip 4 and deployably attached leading edge slats 5, trailing edge flaps 6 and ailerons 7. The wing 1 is intended for attachment to a fuselage of an aircraft (not shown) at the end 8 remote from the wing tip 4.

It will be seen from the exposed view of the end 8 of the wing 1 that the internal structure of the wing is hollow with a number of supporting stringers 9 extending in a generally spanwise direction. The upper and lower surfaces of the wing are covered by a number of planks 10 also running in a generally spanwise direction. The spanwise joints 11 between these planks 10 are potential fuel leakage areas for fuel which is carried within the wing in generally box-shaped compartments bounded by planks 10 and stringers 9.

In FIG. 2 two planks 10 are shown (10′ and 10″) with a spanwise joint 11 between them. The cordwise dashed lines indicate generally the position of wing ribs (22 wing rib positions are shown extending between a leading edge member 12 and a trailing edge member 13).

The enlarged insert in FIG. 2 shows a typical cross section of part of the wing at A showing joint or seam 11 between the two adjacent planks 10′ and 10″ and how those planks support the various stringers 9. Sealant (not shown) is applied along the length of the seam 11 on both sides and it is deficiencies in this sealant which are often the sites of fuel leaks.

A typical inside secondary remote source of leaks 15 in the sealant of the joint 11 is indicated by a black square in the drawing. Such an inner leak source typically gives rise to a primary leak indication 14 on the outer surface of the wing at a place remote from the inner leak source 15 as indicated by the black circle in the drawing.

In order to detect such primary and secondary leak sources certain leak source detection apparatus must be used adjacent the wing surface and in particular adjacent the wing seam or joint 11. This apparatus is shown generally in FIG. 3. The apparatus comprises a vacuum bag or bagging film 16, at least two vacuum valves 17 in the vacuum bag 16 including a vacuum valve hose connector 18 and a vacuum valve base 19. The apparatus further comprises a nylon breather 20 which in use overlays the wing seam 11—having an airweave pad 21 to provide support for the vacuum valve base 19. Sealing tape 22 extends around the periphery of the vacuum bag 16 so that in use it may be attached to the wing surface.

FIG. 4 shows the assembled apparatus in plan view mounted over a spanwise joint 11 between two wing planks 10′ and 10″, ready for leak source detection.

The leak detection apparatus is assembled and used for leak source detection by following the procedure described by steps 1 to 6 below and with reference to the sequence of photographs 5A to 5L.

1.0 Pre Vacuum

1.1 As shown in FIG. 5A, clean a section of the wing surface with low toxin degreasing agent 8 inches, either side of the seam 11 to be tested. It is important to ensure that the section is free of dust, grease, fuel and anything which may prevent tacky tape 22 (see next step) adhering to the surface.

1.2 Next, as shown in FIGS. 5B, 5C and 5D, apply vacuum bag sealant tape (“tacky tape”) six inches either side of the seam to be tested running parallel to the seam ensuring bolt heads are included within the bounds of the tacky tape. Special care must be taken to ensure that the tacky tape 22 follows changes in contour where the seam 11 intersects with another seam or joint. One suitable sealant tape for this purpose is AIRVAC22 AT200Y.

Complete the tacky tape process by taping across two parallel strips at the top and bottom ends of the length of seam 11 to be tested.

DO NOT REMOVE BACKING PAPER.

1.3 As shown in FIG. 5E, cut nylon breather material 20 to match the length of seam 11, ensuring its width falls between the boundary of the tacky tape. Secure blanket 20 within boundary of tacky tape with masking tape (not shown).

One suitable nylon breather material is “Ultraweave” (RTM) 1332 available from Airtech Advanced Materials Group, Corporate HQ, 5700 Skylab Road, Huntingdon Beach, Calif., 92647,

1.4 Cut 3 inch square pieces of nylon breather material as vacuum pads (21) (see FIG. 5F). Place these pads where vacuum valves 17 are to be positioned (i.e. minimum of two at diagonally opposite corners). Tape pads 21 to surface of airbleed material 20. Depending on the length of the seam it may be necessary to use 3 or 4 vacuum valves 17 e.g. for a 25 ft long seam use a minimum of 3 valves.

1.5 Tape the base of the vacuum valve 17 on to the pad 21 ensuring that the tape does not ingress on top surface of the vacuum valve 17 (i.e. place round rim).

1.6 Cut bagging film 16 to overlap tacky tape 22 allowing plenty of excess in case tucks are required. (Minimum: 10 ins overlap all round to allow for tucks). One suitable bagging film material is sold under the code “WL7400”.

1.7 Starting at one end remove backing paper 22′ from tacky tape 22. Apply bagging film 16 to exposed tape 22 and press down firmly.

1.8 Starting at the top end and keeping bagging film 16 taut gradually remove backing tape from the sides, as shown in FIG. 5G, at the same time securing film 16 to tacky tape 22. Cut a cross in vacuum bag 16 at locations vacuum valve base 19 (see FIG. 5H), and screw vacuum valve hose connector top 18 as shown in FIG. 5I.

1.9 Secure other end of bagging film 16 to tacky tape 22.

2.0 Apply Vacuum

2.1 Attach vacuum pipe 18′ to the vacuum valve hose connector top 18, as shown in FIG. 5J, ensuring collar on connector slicks into place. Apply some vacuum ensuring that the bagging film 16 is pulled down evenly along its length with no kinks or tucks around the vacuum valves 17.

2.2 Apply full vacuum, still checking the bagging film 16 for kinks and attach vacuum gauge 17′ to diagonally opposite vacuum valve 17 as shown in FIG. 5K. If there is audible leaking or a rapid drop on vacuum gauge, press on tape and tucks with a dibber 30 as shown in FIG. 5L. The dibber 30 may be a simple PTFE block.

2.3 Using the wandering microphone (not shown) of an Ultrasonic Leak Detector (not shown) carry out full leak checks around the bagged area and around each valve 17. Repeat operation 2.2 until no leaks apparent. The Ultrasonic Leak Detector converts the ultrasonic sound produced by leaking air to an audible frequency and visually displays the amplitude of the sound on a LED meter. The amplitude of the sound increases as the microphone of the Ultrasonic Leak Detector is moved towards an air leak. This step is not essential but is a useful simple pre-check for air leaks which can be used to determine whether subsequent steps need be carried out for any particular seam.

A suitable Ultrasonic Leak Detector is the VACLEAK LEQ-70 available from Tygavac Advanced Materials Ltd, Kingsway West Business Park, Moss Bridge Road, Rochdale, Lancashire, OL16 5LX, who will also supply the tacky tape and the bagging film material.

2.4 Record vacuum indicated on vacuum gauge and compare with the vacuum datum reading established from the test piece (see step 3.2 below). With a dedicated vacuum pump 28 ins Hg is typically the maximum vacuum obtainable.

2.4.1 Take reading.

2.4.2 Disconnect vacuum supply.

2.4.3 Time vacuum loss over one minute, (e.g. the acceptable drop in vacuum is 5 ins Hg in one minute).

3.0 Test Piece

3.1 The amount of vacuum available is dependent upon the type, location and additional users of the compressed air supply. Typically approximately 20 ins Hg of vacuum can be obtained from a compressor available in the average aircraft workshop or hanger.

3.2 To identify the “datum” vacuum available carry out the processes detailed in section 1.0 and 2.0 on a section of wing 1 in which there are no joins and seams 11 and record the maximum consistent vacuum achieved as the “datum” for that task.

4.0 Leak Investigation

If the acceptable drop is exceeded gain physical access to the internal fuel tank. Continue to apply vacuum to the bagged outer surface and using the Ultrasonic Leak Detector, check along the seam joint to determine the source of the leak. Once the leak is detected, locate and mark.

1. In situ.

2. On a graphical record or “leak map”.

Continue investigation to ensure that no additional leaks apparent in that seam or joint. Record any additional leaks detected. Report leaks to appropriate authority.

5.0 Final Leak Check

Repair leaks in accordance with current approved processes. Repeat Stage 2 and Stage 4 ensuring that no further leaks are apparent.

6.0 Refuel Aircraft

Refuel/transfer fuel into the repaired and re-sealed tank in accordance with current approved processes. Monitor site(s) of repair, as referenced on the leak map, for signs of fuel leaks.

Many variations and modifications of the invention will now suggest themselves to those familiar with leak detection technology. For example, before the bagging steps are carried out, potential leakage sites in the seams of the aircraft wing surfaces could be identified by filling the fuel tanks with fuel. Leakage of fuel from the seams would leave witness marks on the wing surface at primary leak source locations. These locations could be subsequently investigated in detail by the method according to the invention.

It will be appreciated that the method of detecting the sites of potential leaks could be applied to a variety of containers, other than aircraft wing fuel storage tanks, for containing fluids, other than aviation fuel. We have also successfully used a variant of the method to test for air leaks in aircraft pressurised vessels e.g. fuselages and fuselage cabins.

1. A method of locating a potential source of fluid leakage in a fluid container includes the steps of:
circumferentially sealing a vacuum tight cover to a surface of the empty fluid container over a suspected source of fluid leak to form a bagged region of said surface;
removing the air between the cover and said bagged region of the surface;
measuring the vacuum between the cover and the surface;
comparing the measured vacuum with a predetermined acceptable datum vacuum value, and, where the measured vacuum exceeds the datum vacuum;
gaining physical access to the interior of the fluid container;
using a leak detector to check suspect areas from the inside; and,
recording the exact location of the source of fluid leaks.

2. A method of locating a potential source of fluid leakage in a fluid container as claimed in claim 1 and wherein the predetermined acceptable vacuum is determined by carrying out the first two of the steps listed in claim 1 on a surface of the fluid container in which there are no joins or seams and recording the maximum consistent vacuum achieved as the datum vacuum value.

3. A method of locating a potential source of fluid leakage in a fluid container as claimed in claim 1 and wherein the vacuum between the cover and said bagged region of the surface of the container is measured over a predetermined period of time and is compared with a predetermined acceptable drop in the datum vacuum value over the same predetermined time.

4. A method of locating a potential source of fluid leakage in a fluid container as claimed in any of the preceding claims and further including the step of using a leak detector to detect air leakage from said bagged region of the surface after the step of removing the air between the cover and the surface and if air leakage is detected appropriately repairing the cover or its seal to the surface.

5. A method of locating a potential source of fluid leakage in a fluid container as claimed in any preceding claim and wherein the leak detector used is an ultrasonic leak detector.

6. A method of locating a potential source of fluid leakage in a fluid container as claimed in any of the preceding claims and, where a potential source of leakage is located, including the further steps of:
repairing the source;
repeating the method and repairing any further sources found; and
filling the container with fluid and monitoring it for fluid leaks.

7. A method of locating a potential source of fuel leakage in an aircraft fuel tank including the steps of:
applying a bagging film to a surface of the empty fuel tank over a suspected source of fuel leak;
removing the air between the bagging film and the surface;
measuring the vacuum between the bagging film and the surface;
comparing the measured vacuum with a predetermined acceptable datum vacuum value; and, where the measured vacuum exceeds the datum vacuum;
gaining physical access to the interior of the aircraft fuel tank;
using a leak detector to check subject areas from the inside; and,
recording the exact location of the source of fuel leaks for subsequent repair.

8. A method of locating a potential source of fuel leakage in an aircraft fuel tank substantially as hereinbefore described and with reference to FIGS. 1 to 4 and 5A to 5L of the accompanying drawings.
